(19) United States
(12) Patent Application Publication
(10) Pub. No.: US 2026/0014837 A1
(43) Pub. Date: Jan. 15, 2026

(54) METHOD FOR PRODUCING A WINDSHIELD HAVING IMPROVED IMPACT PROTECTION, AND WINDSHIELD OF THIS KIND

(71) Applicant: SAINT-GOBAIN GLASS FRANCE, COURBEVOIE (FR)

(72) Inventors: Emmanuel WALCH, HERZOGENRATH (DE); Martin LAKSHMANAN, HERZOGENRATH (DE)

(21) Appl. No.: 18/880,152

(22) PCT Filed: Aug. 8, 2023
(86) PCT No.: PCT/EP2023/071887

§ 371 Date: Dec. 30, 2024

(30) Foreign Application Priority Data
Aug. 15, 2022 (EP) 22190342.0

(51) Int. Cl. B60J 1/02; B32B 17/10

(52) U.S. Cl. CPC B60J 1/02; B32B 17/10036; B32B 17/10082; B32B 17/10889; B32B 17/10761; B32B 17/1077; B32B 17/10788; B32B 2250/03; B32B 2250/40; B32B 2307/558; B32B 2307/7376; B32B 2605/00

(57) ABSTRACT

A method for producing a windshield, includes (a) providing an outer pane and an inner pane, (b) heating the outer pane and the inner pane to at least their softening temperature, (c) jointly bending the outer pane and the inner pane or individually bending the outer pane and the inner pane, (d) cooling the outer pane and the inner pane, and (d) laminating the outer pane and the inner pane with the interposition of a thermoplastic intermediate layer to form a composite pane, wherein in procedure d) the outer pane and/or the inner pane are/is cooled in the first surface region at a first cooling rate and the outer pane and/or the inner pane are/is cooled in the second surface region at a second cooling rate, and the absolute value of the first cooling rate is greater than the absolute value of the second cooling rate.

The invention relates to a method for producing a windshield having improved impact protection and to a windshield of this kind.

Glazings for motor vehicles typically have a bend. There are numerous known methods for bending glass panes. The glass panes are heated to their bending temperature, so that they become plastically deformable, and are bent into the desired shape by means of gravity bending, press bending and/or suction bending. In the case of composite panes, it is advantageous to bend the individual panes simultaneously. Glass panes bent in pairs are matched with one another in terms of their bend and are therefore particularly suitable for being laminated together to form a composite pane. A method for bending glass panes in pairs is known, for example, from EP1358131A2 or EP2463248A1. In so-called gravity bending (or sag bending), the glass pane, which is initially flat, is placed on the support surface of a bending mold. The pane is then heated to at least its softening temperature so that it adheres to the support surface under the influence of gravity. The shape of the glass pane can be influenced by the design of the support surface. The final bend can be achieved by gravity bending. Such a method is known, for example, from GB 813069 A. However, for more complex pane shapes, multi-stage bending methods are often used. Typically, a pre-bend is created in a first bending step using gravity bending, whereas the final shape is created in a second bending step—often by press bending between two complementary bending molds. Such multi-stage bending methods are known, for example, from EP 1 836 136 B1, U.S. Pat. No. 20,041,07729 A1, EP 0531152 A2 and EP 1371616 A1. Gravity bending methods also allow a pair of panes to be jointly bent congruently, for example a pair of panes to be laminated to form a composite pane. Panes bent in pairs have smaller deviations from one another in terms of curvature than panes bent individually.

In the automotive industry in particular, there is a trend towards the use of thinner and therefore lighter glass in composite glass panes as part of efforts to reduce weight and thus achieve fuel and electricity savings. Nevertheless, such glazings must meet defined mechanical requirements that are fixed in relevant industrial standards. In this context, safety requirements increase not only for vehicle occupants but also for other road users, such as pedestrians. In the event of a head-on collision between a pedestrian and a car, the pedestrian is very likely to hit the hood of the car, causing their head to hit the windshield of the car. This can result in severe or even fatal injury to the pedestrian, in particular if their head smashes through the windshield and hits other objects such as the dashboard. The windshield can be prevented from being broken by adjusting the materials and layer thicknesses of the composite pane, which increases the production costs and weight of the composite pane as well as the effort required for production.

JP 2008133141 A discloses a composite pane comprising an outer glass pane and an inner glass pane which are connected to one another via an intermediate layer, wherein the intermediate layer has a first region and a second region and the intermediate layer has a higher tensile stiffness in the first region than in the second region.

DE 2640206 A1 describes a laminated windshield comprising two glass panes connected by a plastics material interlayer, each of the glass panes having a thickness of 1.5 mm to 2.5 mm and a plane compression stress of 200 kg/cm² to 500 kg/cm².

Accordingly, there is a need for a method for producing composite panes having improved impact protection that enables simple and cost-effective production without the use of additional raw materials.

The present invention is based on the object of providing a production method for windshields having improved impact protection, which enables simple production and does not increase the weight of the windshield.

The object of the invention is achieved in accordance with the invention by a method for producing a windshield, the method at least comprising the following method steps:
(a) providing an outer pane and an inner pane,
(b) heating the outer pane and the inner pane to at least their softening temperature,
(c) jointly bending the outer pane and the inner pane or individually bending the outer pane and the inner pane,
(d) cooling the outer pane and the inner pane,
(e) laminating the outer pane and the inner pane with the interposition of a thermoplastic intermediate layer to form a composite pane.

The windshield comprises an outer pane and an inner pane which are connected to one another via a thermoplastic intermediate layer in step e) of the method. The windshield has a roof edge, an engine edge and two side edges opposite one another, which connect the roof edge and the engine edge to one another. A first surface region of the windshield is located in the immediate vicinity of the engine edge, while a second surface region of the windshield is arranged immediately adjacent to the first surface region between the first surface region and the roof edge. The inner pane and the outer pane also have a roof edge, an engine edge, two side edges, a first surface region and a second surface region, wherein these are arranged congruently after lamination of the inner pane and the outer pane, and the edges of the inner pane and of the outer pane together form the roof edge, the engine edge and the side edges, respectively. In step d) of the method according to the invention, the outer pane and/or the inner pane are/is cooled in the first surface region at a first cooling rate and the outer pane and/or the inner pane are/is cooled in the second surface region at a second cooling rate, wherein the absolute value of the first cooling rate is greater than the absolute value of the second cooling rate. Thus, the inner pane and/or the outer pane in the first surface region adjacent to the engine edge are cooled faster than the inner pane and/or the outer pane in the second surface region. The cooling rate describes the cooling rate prevailing at one of the pane surfaces of the inner pane and/or outer pane. The faster a glass pane is cooled, the higher the surface compressive stresses that arise in the glass. The inventors have made use of this principle to develop a method with which the breakage properties of a windshield can be adjusted differently in the first and second surface regions of the pane.

The inventors have found that the windshield in the first surface region has improved breakage characteristics when an object hits the windshield. The first surface region is the region adjacent to the engine edge, where a pedestrian's head is more likely to hit in the event of an accident. In the first surface region, in which the outer pane and/or the inner pane of the windshield has a higher surface compressive stress than in the second surface region, a later breakage occurs upon impact with a body. In the event of a later glass breakage following a head impact in the first surface region, an impact of the head on elements located behind the windshield in the vehicle interior is avoided. In the second surface region of the windshield, lower surface compressive stresses are introduced in the method according to the invention than in the first surface region. This causes the pane to break early if an object hits the second surface region. After one or both of the glass panes break, a considerable amount of energy is absorbed due to the expansion of the thermoplastic intermediate layer and the at least partial delamination in the region of the broken glass panes. The thermoplastic intermediate layer is expandable and therefore yields, so that the head slows down less abruptly and experiences a lower deceleration rate. To quantify the head impact, the Head Injury Criterion (HIC) is used, for example, which assesses the severity of an impact based on the deceleration rate of the head. High deceleration rates are usually associated with high HIC values, which are associated with severe injuries to the head of the pedestrian. A low HIC value is equivalent to a low risk for severe head injuries. A windshield produced using the method according to the invention also offers greater safety for a pedestrian in the event of a traffic accident involving the pedestrian, since the severity of the impact of the human head in the event of a head-on collision is mitigated by early breakage in the second surface region and subsequent breakage in the first surface region of the windshield.

The cooling rate of a surface region represents the average cooling rate in this surface region. The cooling rate within a surface region can be adjusted, for example, by gas flows applied to the pane, wherein, for example, the volume flow of the gas is selected to be greater in regions with a higher cooling rate than in regions with a lower cooling rate. Alternatively or additionally, a gas volume flow can be subjected to different temperatures depending on the desired cooling rate. With reference to an exemplary embodiment of a method with gas cooling, the adjacent surface regions can be separated from one another, for example, by means of covers arranged between the gas outlet openings, so that a sudden change in the cooling rates occurs along the region boundary between a first surface region and a second surface region. In a further exemplary embodiment of the method, no covers or other separations are provided between gas outlets with different temperatures and/or volume flows. In this case, there is a first surface region with a first cooling rate, a second surface region with a second cooling rate and a third surface region with a third cooling rate. The second surface region is a transition between the first surface region and the third surface region, wherein in the first surface region the cooling rate is determined by a first volume flow impinging there, in the third surface region the cooling rate is determined by a second volume flow impinging in this region and in the second surface region the first and second volume flows impinge in an overlapping manner and their sum determines the cooling rate of the second surface region. In this case, too, there is a specific delimitation of the surface regions based on the surfaces on which the gas volume flows impinge and cause the corresponding cooling rate. The application of a gas to the pane is mentioned here only as an example; the surface regions can also be designed with the aid of other cooling devices. If the cooling rate is determined using various points regularly distributed along the pane, this results in the surface regions according to the invention in the sense that adjacent points of the same or similar cooling rate lie within the same surface region. Preferably, the deviation of the cooling rate within a surface region is a maximum of 30%, preferably a maximum of 20%, in particular a maximum of 10%, based on the average cooling rate present in this surface region.

The windshield is provided for separating a vehicle interior from an external environment. The windshield is therefore a window pane that is inserted into a window opening in the vehicle body or is provided for this purpose. The windshield is inserted between the hood, the body roof and the A-pillars of the vehicle body in the opening provided in the body. The edge of the windshield closest to the engine region of the vehicle in the installed state is referred to as the engine edge, while the edge opposite the engine edge is called the roof edge and is oriented adjacent to the vehicle roof. The two edges of the windshield that run adjacent to the A-pillars are referred to as the side edges of the windshield and connect the engine edge and the roof edge. The first pane is the outer pane of the windshield, which faces the vehicle surroundings, while the second pane of the windshield is the inner pane, which is oriented to the vehicle interior. It is understood that the first pane, the second pane and the thermoplastic intermediate layer have substantially the same outer dimensions. The surface of the relevant pane which faces the external surroundings of the vehicle when installed is referred to as the outer surface. The surface of the respective pane that faces the interior of the vehicle in the installed position is referred to as the interior-side surface. The interior-side surface of the outer pane is connected to the outer surface of the inner pane via the thermoplastic intermediate layer. The outer surface of the outer pane is usually referred to as “side I,” the interior-side surface of the outer pane as “side II,” the outer surface of the inner pane as “side III,” and the interior-side surface of the inner pane as “side IV.”

The windshield comprises at least a first surface region and a second surface region, wherein the first surface region is located directly adjacent to the engine edge and the second surface region directly adjoins the first surface region on the side facing away from the engine edge. The first surface region and the second surface region are adjacent to one another and do not overlap. In a preferred embodiment of the method, the windshield comprises only a first surface region and a second surface region, the surface areas of which add up to the total surface area of the windshield. In a further preferred embodiment, the windshield has at least one third surface region which directly adjoins the second surface region on the side thereof facing away from the first surface region. Optionally, the windshield can comprise further surface regions, wherein the surface areas of the first surface region, the second surface region, the third surface region and optionally further surface regions add up to the total surface area of the windshield. The first surface region is located immediately adjacent to the engine edge, i.e., there is no further surface region between the engine edge and the first surface region. The second surface region is at a greater distance from the engine edge than the first surface region and directly adjoins the first surface region. A third surface region, if present, is at a greater distance from the engine edge than the second surface region and directly adjoins the second surface region. Analogously, further surface regions can be arranged beyond the third surface region. The sequence of surface regions with increasing distance from the engine edge is in this case first surface region, second surface region, optionally third surface region and also optionally further surface regions.

In a preferred embodiment of the method according to the invention, the ratio between the first cooling rate (A1) and the second cooling rate (A2) as A1/A2 is greater than or equal to 2, preferably as A1/A2 between 2 and 3, particularly preferably as A1/A2 between 2 and 2.5. In these regions, an advantageous increase in the surface compressive stresses is achieved in the first surface region compared to the second surface region, so that there is a later breakage of the pane in the first surface region upon impact of a body. At the same time, the ratio of the cooling rates is selected in such a way that breakage of the windshield during the cooling process is avoided. Preferably, the aforementioned ratios of the cooling rates are present on one or both of the pane surfaces exposed to the environment, i.e., on the interior-side surface of the inner pane and/or on the exterior surface of the outer pane.

Preferably, the outer pane and/or the inner pane are cooled in the first surface region at a first cooling rate A1 between 6 K/s and 20 K/s, particularly preferably between 10 K/s and 15 K/s. In the second surface region, the cooling rate is preferably between 0.5 K/s and 2 K/s. cooled. Such a cooling rate A1 in the first surface region leads to advantageous surface compressive stresses at which sufficient stone impact resistance and advantageous breakage properties upon impact with a body can be achieved at the same time. The cooling rate A2 in the second surface region is adapted to the cooling rate A1 of the first surface region in such a way that stresses at the transition between the two regions are further minimized.

Preferably, the windshield of the method according to the invention has exactly a first surface region and a second surface region which maintain the described ratio of cooling rates. Thus, in the method according to the invention only two different cooling rates have to be achieved during the cooling process, which simplifies the method. In a further preferred embodiment, the windshield of the method according to the invention has a first, a second and a third surface region, wherein the preferred ratios of the first and the second cooling rate are present between the first and the second surface region. In the third surface region, cooling occurs at a lower cooling rate than in the first surface region, so the third surface region is cooled more slowly than the first surface region. The second surface region serves as a transition region between the first and the third surface region, whereby a gradual transition can be created between regions with a high cooling rate and those with a low cooling rate.

At the start of the cooling process in step d), the outer pane and/or the inner pane preferably have a temperature of at least 500° C., particularly preferably of at least 520° C. If the panes are cooled from such high initial temperatures, high compressive stresses can advantageously be achieved, and improved breakage properties in the first surface region are achieved, particularly when the preferred cooling rates are maintained.

The cooling of the outer pane and/or the inner pane in step d) is preferably carried out by convection or radiatively. Suitable cooling devices are known to a person skilled in the art. For convective cooling, for example, fans can be used, wherein in the region of the first surface region a fan applies gas with a higher volume flow and the second surface region is exposed to a lower gas volume flow by means of another fan. In a further embodiment, a first fan is arranged in the region of a first surface region of the inner pane and/or outer pane and a second fan is arranged in the region of a third surface region of the inner pane and/or outer pane, wherein the gas volume flow generated by means of the first fan is higher than the gas volume flow generated by means of the second fan and between the first surface region and the third surface region there is a second surface region in which the gas volume flows of the first fan and the second fan partially overlap. Connected regions with the same level of impinging gas volume flow form a surface region with the same or similar cooling rate, while the value of the impinging gas volume flow changes at the region boundary between adjacent surface regions. The cooling rate therefore changes gradually from surface region to surface region. If the transition from a surface region with a low cooling rate to a surface region with a higher cooling rate is to be as homogeneous as possible, further surface regions can be provided between these two surface regions, the cooling rates of which lie between the cooling rates of the first-mentioned surface regions. The more intermediate surface regions are selected and the smaller they are, the more continuous the transition between high and low cooling rates will be. A gradual transition is maintained and only the small-scale nature of the surface regions leads to a more homogeneous-looking transition. Instead of a first fan and a second fan, a single fan can also be used, followed by a distribution box for dividing the volume flow generated by the fan into a first gas volume flow for the first surface region and a second gas volume flow for the second surface region. The distribution box can contain flaps, deflectors, nozzles, valves and/or other elements for regulating and controlling a gas volume flow, which make it possible to adjust the ratio of the first gas volume flow to the second gas volume flow. In a preferred embodiment, the gas used for cooling is air. In principle, however, other gases can also be used, such as carbon dioxide or nitrogen. The temperature of the gas is lower than the temperature of the panes to be cooled and preferably corresponds to the ambient temperature, for example 20° C. to 40° C.

The bending of the outer pane and/or the inner pane in step c) is carried out using the conventional industrial bending methods, which also include gravity bending and press bending. According to the invention, the cooling step in step d) is carried out immediately after the bending process at a time when the temperature of the panes is high and must be reduced before the panes are joined in step e). Even in a prior art method not according to the invention, between bending and lamination of the panes, provision is made for passive or active cooling of the panes to a temperature at which lamination can take place. According to the invention, this step is replaced by an active cooling step in which the cooling of the panes takes place at different cooling rates depending on the surface region. There is no additional time expenditure, such that the cycle time in the production cycle remains constant.

In a particularly preferred embodiment of the invention, the outer pane and the inner pane are bent in a gravity bending method. In particular, the inner pane and the outer pane are bent congruently, preferably jointly bent congruently.

In a conventional gravity bending method, gravity acts on the softened glass pane, which consequently adheres to the bending mold. This process can additionally be supported by applying an overpressure to the glass pane. The overpressure causes the softened glass pane to be pressed into the bending mold, thereby supporting the effect of gravity. Devices for gravity bending at least one glass pane comprise at least a lower gravity bending mold and an upper forming tool. The glass pane to be bent is placed on the gravity bending mold and positioned between the gravity bending mold and the upper forming tool. The gravity bending mold has a support surface which is suitable for arranging at least one glass pane thereon. The support surface determines the shape of the curved glass pane. If the glass pane is heated to at least its softening temperature, it adheres to the support surface under the influence of gravity, thereby achieving the desired shape. A gravity bending mold is a so-called lower mold on which the pane can be placed, so that the support surface touches the lower surface of the glass pane facing the ground. Usually, the edge region of the glass pane overlaps the support surface all the way around. The support surface is preferably concave. A concave shape is understood to be a shape in which the corners and edges of the glass pane are bent in the direction away from the bending mold when in intended contact with the support surface.

The support surface can, for example, be designed to cover the entire surface and be brought into contact with the glass pane over its entire surface. In a preferred embodiment, however, the gravity bending mold has a frame-like support surface. Only the frame-like support surface is in direct contact with the glass pane, while the largest part of the pane has no direct contact with the tool. This makes it possible to produce panes of particularly high optical quality. Such a tool can also be called a ring (bending ring) or frame (frame mold). The support surface does not have to form a complete frame, but can also be interrupted.

In one possible embodiment, the gravity bending mold can be moved vertically relative to a second lower mold to transfer the glass pane between the gravity bending mold and the second lower mold. The gravity bending mold and the second lower mold are in particular part of a multi-part bending tool. Preferably, the second lower mold is also frame-like and concave. The gravity bending mold may be arranged within the second lower mold. This means that the support surface of the second lower mold has a larger circumference than the support surface of the gravity bending mold and is a greater distance from the center of the multi-part bending tool-the second lower mold therefore surrounds the gravity bending mold. Alternatively, the second lower mold can also be arranged within the gravity bending mold. The gravity mold is vertically movable relative to the second lower mold to transfer the glass pane between the gravity bending mold and the second lower mold. During the gravity bending process, the gravity bending mold is positioned above the second lower mold and the pane rests on the support surface of the gravity bending mold. The gravity bending mold is then moved vertically downwards relative to the second lower mold. What is important here is the relative movement of the two molds against one another, wherein the actual physical movement can be made by the gravity bending mold (downwards), the second lower mold (upwards) or both. As soon as the support surface of the gravity bending mold is positioned below the support surface of the second lower mold, the glass pane rests on the support surface of the second lower mold and the support surface of the gravity bending mold is free. The glass pane is transferred from the gravity bending mold to the second lower mold. In an advantageous embodiment, the second lower mold is also a gravity bending mold, but with a stronger curvature than the first gravity bending mold.

Expediently, the support surface of the second lower mold has a different geometry, in particular curvature, than the support surface of the gravity bending mold. The second lower mold is provided for a further bending step in which a more complex, typically more curved pane shape is achieved. Since at the time of transfer the glass pane has the bend determined by the gravity bending mold, after transfer it rests on the second lower mold only at a few points, typically in the region of the corners of the pane. Only during the subsequent bending step does the glass pane assume the bend defined by the support surface of the second lower mold and then rests on the entire support surface.

The upper forming tool is arranged opposite the support surface of the gravity bending mold during the bending process, so that a glass pane can be arranged between the gravity bending mold and the forming tool. It is suitable for generating an overpressure on the surface of the glass pane arranged on the support surface that faces away from the support surface. The forming tool is not designed as a mold with a full-surface contact area, but as a hollow mold. The forming tool has a cover, for example made of a metal sheet. The cover is shaped in such a way that it forms a cavity. The cavity is not a closed cavity, but has a large opening that faces the gravity bending mold. The tool can also be described as bell-shaped or hood-shaped.

A common device for gravity bending also comprises means for moving the gravity bending mold and the forming tool against one another. As a result, after the glass pane has been placed on the gravity bending mold, the gravity bending mold and the forming tool are brought closer together, so that the forming tool is brought into contact with the glass pane. By moving the gravity bending mold, the forming tool, or both, these can be brought closer together. In a preferred embodiment, the forming tool is moved and lowered onto the glass pane, whereas the gravity bending mold does not perform any vertical movement.

A gravity bending device also comprises means for heating the glass pane to softening temperature. Typically, the gravity bending mold and the upper forming tool are arranged within a heated bending furnace or a heated bending chamber. The glass pane can pass through a separate chamber for heating, such as a tunnel furnace.

The gravity bending method described as an example can be the only bending step or part of a multi-stage bending method that is preceded or followed by further bending steps. For example, after gravity bending and before cooling in step d), further bending steps can be carried out, for example by means of gravity bending, press bending or suction bending. For this purpose, the pane can be transferred from the gravity bending mold to other bending molds. In an advantageous embodiment, a complex pre-bending of the glass pane is achieved by two gravity bending steps, while the final pane shape is achieved in a subsequent press bending step. In this way, particularly complex pane geometries can be implemented.

The outer pane and/or the inner pane, preferably both panes, are shaped in step c) of the method according to the invention, preferably by means of gravity bending. The inner pane and the outer pane can be bent simultaneously as two glass panes lying on top of one another. This is particularly desirable because these panes will later be laminated to form a composite glass so that their shape is optimally matched. For this purpose, the glass panes are arranged flat on top of one another and simultaneously bent congruently. A separating agent, such as a separating powder or a fabric, is arranged between the glass panes so that the glass panes can be separated from one another again after bending.

In a preferred embodiment of the method according to the invention, the outer pane and the inner pane are congruently bent together in pairs and then cooled together in pairs. The convective or radiative cooling is preferably carried out from the interior-side surface of the inner pane. When gravity bending the inner pane and the outer pane in pairs, the outer surface of the outer pane is usually the surface facing the gravity bending mold, while the interior-side surface of the inner pane represents the surface of the pane pair facing the surroundings. The interior-side surface of the inner pane is therefore freely accessible even when the pane pair rests on a gravity bending mold. Preferably, a cooling device, such as a radiative or convective cooling device, is positioned adjacent to the easily accessible interior-side surface of the inner pane. This creates surface compressive stresses that are beneficial for the breakage behavior of the windshield being produced, particularly on the interior-side surface of the inner pane.

In a preferred embodiment of the method according to the invention, the outer pane and/or the outer pane are bent by means of press bending. Particularly preferably, the inner pane and the outer pane are bent in step c) simultaneously in pairs or successively by means of press bending. A press bending method can be used as the sole bending method in step c) or can follow a gravity bending method. In the so-called press bending methods, the pane or panes to be bent are arranged between two complementary tools, which together exert a pressing effect on the pane or panes in order to create the bend. In press bending, a lower press bending mold with a frame-like contact area is often used, on which only the side edge of the glass pane rests along a circumferential contact line. The contact area is typically flat and inclined inwards. This merely linear contact between the glass pane and the contact area is advantageous in order to avoid tool marks and the associated reduction in optical quality. If the glass pane is pressed and deformed by the upper press-bending mold (often a so-called full mold with a full-surface effective area) into the lower press-bending mold, the aforementioned contact line migrates from the outside to the inside as a result of the increasing bending of the pane on the contact area. The linear contact with the contact area is maintained throughout the entire process, and the main surface of the pane does not come into contact with the lower press-bending mold. Press bending methods of this type are described, for example, in DE10314267B3, WO2007125973A1, EP0677488A2 or WO9707066A1. An upper bending tool is understood to mean a tool that contacts the upper main surface of the glass pane facing away from the ground. Its contact area faces downwards. A lower bending mold is a mold that contacts the lower main surface of the glass pane facing the ground. Its contact area faces upwards. The lower bending mold has a full-surface contact area. For the purposes of the invention, a full-surface contact area is understood to mean a contact area that comes into contact with the entire or a large part of the surface of the glass pane to be bent. The lower bending mold can also be called a full mold or solid bending mold. These terms are familiar to a person skilled in the art and serve in particular to distinguish them from a so-called frame mold, which has only a frame-like contact area which only comes into contact with a peripheral edge region of the glass pane, while the majority of the glass pane, in particular its central region, has no direct contact with the frame mold.

The glass pane can be transferred to the storage mold after press bending using the upper bending tool that was used for press bending. After press bending, the glass pane remains in place on the contact area of the upper bending tool, the lower press bending mold is removed and the storage mold is moved under the bending tool so that the glass pane can be placed on it. However, it is also possible for the glass pane to remain on the lower bending mold after press bending and to be removed from the upper bending tool. The upper bending tool is then available for the next bending step, which has advantages in terms of cycle time. The glass pane is then taken from the lower bending mold by another tool, for example another upper press-bending tool or a similarly designed holding tool, and placed on the storage mold.

In an advantageous embodiment, the method is applied simultaneously to at least two, preferably exactly two, glass panes lying on top of one another. The glass panes are held in pairs (i.e., as a pair of panes) simultaneously by the tool and bent in the bending process. The bend of the two glass panes is in this case particularly congruent and matched with one another, so that the panes are particularly suitable for being laminated together to form a composite pane of high optical quality. If two or more panes of glass are bent simultaneously, a separating agent is preferably arranged between the panes so that the panes do not permanently adhere to one another. When bending in pairs, all method steps are carried out with the pair of panes-the glass panes, which are flat in their initial state, are arranged on top of one another and jointly subjected to pre-bending and press bending.

Depending on which of the panes is to be subjected to increased surface compressive stresses, the inner pane and the outer pane are preferably bent in pairs or preferably individually by means of gravity bending and/or press bending. During the bending method, the outer pane is usually the pane facing the lower bending mold, while the inner pane rests on the outer pane and faces away from the lower bending mold. If increased surface compressive stresses are to be provided primarily in the first surface region of the inner pane, the inner pane and the outer pane are preferably bent jointly and, after removal of the upper bending mold, subjected to the cooling step, step d), wherein a cooling device is arranged adjacent to the interior-side surface of the inner pane. In this case, the heat from the outer pane is dissipated via the inner pane, wherein the outer pane cools down more slowly than the inner pane and thus has lower surface compressive stresses than the inner pane. If the outer pane is to have similar surface compressive stresses to those of the inner pane, the outer pane and the inner pane are preferably bent individually and individually subjected to the cooling step according to the invention, wherein the cooling device is preferably arranged on the interior-side surface of the outer pane and of the inner pane.

The outer pane and the inner pane are preferably made of soda-lime glass, as is customary for window panes. The transition point of soda-lime glass is about 560° C., although its exact value depends on the exact composition. In principle, however, the glass pane can also be made of other types of glass, such as borosilicate glass, aluminosilicate glass or quartz glass. The thickness of the panes is typically from 0.5 mm to 5 mm, in particular from 1.2 mm to 3 mm.

Typical bending temperatures for glass panes made of soda-lime glass are between 570° C. and 700° C. It may be preferable to significantly exceed the transition point: firstly, the glass can be formed more easily and quickly due to its lower viscosity, and secondly, higher temperatures are required to introduce the edge stress into the glass pane that is required for vehicle windows. The bending temperature in gravity bending is preferably between 600° C. and 650° C. and in press bending a maximum of 600° C., preferably 500° C. to 600° C. The lower temperature in press bending results in a better optical quality of the glass pane.

The invention further comprises a windshield obtainable by the method according to the invention. The features described for the method according to the invention also apply to the windshield and vice versa.

The windshield according to the invention comprises at least one outer pane made of glass with an outer surface, also referred to as side I, and an interior-side surface, also referred to as side II, an inner pane made of glass with an outer surface, also referred to as side III, and an interior-side surface, also referred to as side IV. The interior-side surface II of the outer pane and the outer surface III of the inner pane are connected to one another by a thermoplastic intermediate layer. The windshield has a roof edge, an engine edge and two side edges running therebetween. When installed in a vehicle body, the roof edge is adjacent to the vehicle roof, while the engine edge is adjacent to the hood of the vehicle. Between the engine edge and the roof edge run two opposite side edges, each of which is located adjacent to a so-called A-pillar of the body. The windshield has at least a first surface region immediately adjacent to the engine edge and a second surface region between the first surface region and the roof edge. The outer pane and/or the inner pane has a surface compressive stress of 11 MPa to 50 MPa, preferably 15 MPa to 30 MPa, in the first surface region, while the outer pane and/or the inner pane has a surface compressive stress of 2 MPa to 10 MPa in the second surface region.

Methods for determining surface compressive stresses are known to a person skilled in the art. For this purpose, various optical measuring devices are commercially available, such as so-called differential surface refractometers (DSR), epibiascopes and scattered light polariscopes. In DSR devices, light falls through a prism onto the glass pane surface and is totally reflected. After exiting the prism, the light rays are passed through an interference filter and the surface compressive stress can be determined from the difference relative to the initial radiation. Epibiascopes send focused light onto the glass surface, creating boundary layer waves whose elliptical oscillation state is changed by a fringe compensator. The resulting interference fringes have an inclination angle, which is a measure of the surface tension. Scattered light methods for measuring surface compressive stress make use of the so-called Tryndall effect, according to which light entering a transparent medium is scattered to a certain extent. The different intensities of the scattered light along the light path within the medium are recorded and evaluated to determine the corresponding compressive stresses.

Preferably, all surface compressive stresses mentioned in connection with the invention are determined by means of epibiascopy, for example by means of the LaserGasp epibiascope from Strainoptics. The other methods mentioned are also applicable.

On a windshield according to the invention, the surface regions can thus be determined by measuring the surface compressive stresses. If the surface compressive stress is determined using various points regularly distributed along the pane, this results in the surface regions according to the invention in the sense that adjacent points of the same or similar surface compressive stress lie within the same surface region. Preferably, the deviation of the surface compressive stresses within a surface region is a maximum of 30%, preferably a maximum of 20%, in particular a maximum of 10%, based on the average surface compressive stress present in this surface region.

The windshield according to the invention has improved breakage characteristics in the first surface region when an object hits the windshield. The first surface region is the region adjacent to the engine edge, where a pedestrian's head is more likely to hit in the event of an accident. The targeted introduction of increased surface compressive stresses in the first surface region of the outer pane and/or inner pane of the windshield leads to a later breakage in the first surface region and an early breakage in the second surface region in the event of an impact with a body. In the second surface region, after one or both of the glass panes break, a considerable amount of energy is absorbed due to the expansion of the thermoplastic intermediate layer and the at least partial delamination in the region of the broken glass panes. The thermoplastic intermediate layer is expandable and therefore yields, so that the head slows down less abruptly and experiences a lower deceleration rate. In the first surface region, where elements such as the dashboard are usually located behind the windshield, the panes break later, thus preventing the head from hitting objects behind them. To quantify the head impact, the Head Injury Criterion (HIC) is used for example, which assesses the severity of an impact based on the deceleration rate of the head. High deceleration rates are usually associated with high HIC values, which are associated with severe injuries to the head of the pedestrian. A low HIC value is equivalent to a low risk for severe head injuries. In the first surface region, higher surface compressive stresses are introduced into the glass, which deliberately cause a later breakage. As a result, the windshield according to the invention also offers greater safety for a pedestrian in the event of a traffic accident involving the pedestrian, since the severity of the impact of the human head in the event of a head-on collision is mitigated.

In a preferred embodiment, the windshield in the first surface region has a surface compressive stress of 11 MPa to 50 MPa, preferably 15 MPa to 30 MPa, on the interior-side surface of the outer pane and/or on the interior-side surface of the inner pane. These surface compressive stresses are preferably applied to the interior-side surface of the outer pane and/or the interior-side surface of the inner pane, since a breakage of the windshield does not occur directly as a result of the impact with an object on the outside of the windshield, but rather as a result of the tensile stress generated in the glass, in particular on the interior-side surfaces of the outer pane and the inner pane. This is the case in particular with semi-hard objects, such as a human head. The windshield first breaks at the points at which the tensile stress is greatest. If an impact occurs on the outer surface of the outer pane, the greatest tensile stresses arise on the interior-side surface of the outer pane and on the interior-side surface of the inner pane. If the aforementioned surface compressive stresses are applied in one of these surfaces, the desired later breakage occurs there. Particularly preferably, the above-mentioned surface compressive stresses are applied in the first surface region at least on the interior-side surface of the inner pane. On the one hand, the highest tensile stresses occur on this surface, and on the other hand, it is a pane surface that is easily accessible in the cooling step (step d) following the bending step (step c). In a further possible embodiment, the above-mentioned preferred surface compressive stresses are present on the outer surface of the outer pane and/or on the outer surface of the inner pane. This embodiment can also achieve an improvement in the breakage characteristics compared to windshields not according to the invention. However, the first embodiment, in which the above-mentioned surface compressive stresses are present on the interior-side surfaces, has proven to be more advantageous for the reasons mentioned.

Preferably, the first surface region takes up between 10% and 70%, preferably 15% to 50%, particularly preferably 20% to 40%, of the total surface area of the windshield. The aforementioned preferred surface regions of the first surface region are sufficient to achieve a good level of safety in the head impact test.

Preferably, the first surface region extends at least in portions from the engine edge of the windshield by an amount in the direction of the roof edge of the windshield that corresponds to 10% to 70% of the height of the windshield.

The height of the windshield is determined by measuring the shortest distance to the roof edge at the relevant position of the engine edge. Subsequently, the amount by which the first surface region extends in the direction of the roof edge is determined at the same position of the engine edge as the shortest distance between the engine edge and the upper edge of the first surface region offset in the direction of the roof edge, which results in the height of the first surface region at this position along the engine edge. This height of the first surface region is set in relation to the height of the windshield, measured in each case at the same position along the windshield, thereby obtaining the relative amount by which the first surface region extends from the engine edge in the direction of the roof edge. The height up to which the first surface region extends is determined on the basis of the vehicle geometry, wherein the region in which the head of a pedestrian would most likely hit in the event of an accident is preferably located in the first surface region. The first surface region is attached adjacent to the engine edge and extends from there, at least in portions, up to the mentioned height of the windshield. “In portions” means that the first surface region projects into the windshield in at least one portion along the engine edge of the windshield up to the specified height in the direction of the roof edge, but can also have a lower height in other portions. The upper edge of the first surface region, i.e., the edge section of the first surface region with the greatest distance from the engine edge of the windshield, preferably runs in a straight line or a curve between the side edges of the windshield.

In a particularly preferred embodiment, the size of the first surface region is selected such that, in the installed state of the windshield in a motor vehicle, the size of the first surface region corresponds to at least 90% of the area of the projection of the dashboard of the motor vehicle onto the windshield. Particularly preferably, the size of the first surface region corresponds to at least the area of the projection of the dashboard onto the windshield. A windshield is always produced for a specific vehicle model, so that the vehicle model, its body structure, the installation situation in the vehicle and also the design of the dashboard are already known based on the windshield itself. A common accident scenario involving pedestrians is that the pedestrian's head hits the windshield in the region of the dashboard, increasing the probability of serious injury. In this respect, it is advantageous to design the region of the windshield which, when installed, is covered by a projection of the dashboard onto the windshield as the first surface region, as a result of which the windshield breaks later in this surface region and the head is prevented from hitting the dashboard.

The thermoplastic intermediate layer preferably comprises polyvinyl butyral (PVB), polyurethane (PU), ionomers and/or ethylene vinyl acetate (EVA), particularly preferably PVB. These materials have proven to be particularly suitable with regard to a secure connection of the panes to one another.

The thickness of the thermoplastic intermediate layer is preferably between 300 μm and 1000 μm, particularly preferably between 500 μm and 900 μm, in particular between 650 μm and 850 μm.

The outer pane and the inner pane are made of glass, preferably soda-lime glass, as is customary for window panes. However, the panes can also be manufactured from other types of glass, for example quartz glass, borosilicate glass or aluminosilicate glass.

The outer pane and the inner pane in each case preferably have a thickness of 0.8 mm to 2.5 mm, particularly preferably from 1.2 mm to 2.2 mm. The thickness of the outer pane is typically between 1.0 mm and 2.5 mm. The thickness of the inner pane is preferably between 0.8 mm and 2.1 mm. The thickness of the outer pane is preferably greater than the thickness of the inner pane. For example, the outer pane can be 2.1 mm thick and the inner pane 1.1 mm thick, or the outer pane 1.8 mm thick and the inner pane 1.4 mm thick, or the outer pane 1.6 mm thick and the inner pane 1.1 mm thick, or the outer pane 1.6 mm thick and the inner pane 0.7 mm thick, or the outer pane 1.4 mm thick and the inner pane 1.1 mm thick.

The inner pane, the outer pane and the thermoplastic intermediate layer can be clear and colorless, but can also be tinted or colored. The tinting of the outer pane, inner pane and of the thermoplastic intermediate layer is selected as a function of the desired application of the composite pane. For windshields, high transmission in the visible range of the light spectrum is desired and dark tinting of the components is omitted. In one embodiment of the windshield for a motor vehicle, the total transmission through the windshield is greater than 70%, based on light type A. The term “total transmission” relates to the method defined by ECE-R 43, Annex 3, Section 9.1 for testing the light transmission of motor vehicle panes.

The windshield according to the invention is preferably curved in one or more spatial directions, as is usual for windshields of motor vehicles, wherein the typical radii of curvature are in a range of approximately 10 cm to approximately 40 m. However, the windshield can also be flat, for example if it is provided as a pane for buses or tractors.

The inner pane, the outer pane, and/or the thermoplastic intermediate layer can have further, suitable coatings known per se, e.g., anti-reflective coatings, non-stick coatings, anti-scratch coatings, photocatalytic coatings or sun protection coatings or low-e coatings.

Automotive glazings, in particular windshields, rear windows, and roof panes, usually have a peripheral cover print made of an opaque enamel, which in particular serves to protect and optically cover the adhesive used for installing the pane from UV radiation. Preferably, at least the outer pane has such an opaque peripheral cover print, particularly preferably both the outer pane and the inner pane are printed, so that the through-view from either side is prevented. The opaque cover print is applied in the form of a screen print, for example, so that this screen print circumscribes the field of view of the pane or forms its outer edge. An electrical conductor that may be arranged in the edge region of the pane and, in the case of coated panes, an optionally provided coating-free edge region are preferably covered by this cover print and are therefore optically concealed. The opaque screen print can be applied in any plane of the windshield.

The invention further relates to a motor vehicle comprising a windshield according to the invention, wherein the size of the first surface region is selected such that, in the installed state of the windshield in the motor vehicle, the size of the first surface region corresponds to at least 90% of the area of the projection of the dashboard of the motor vehicle onto the windshield.

In the following, the invention is explained in more detail with the aid of a drawing and examples of embodiments. The drawing is a schematic representation and is not true to scale. The drawing does not limit the invention in any way.

In the drawings:

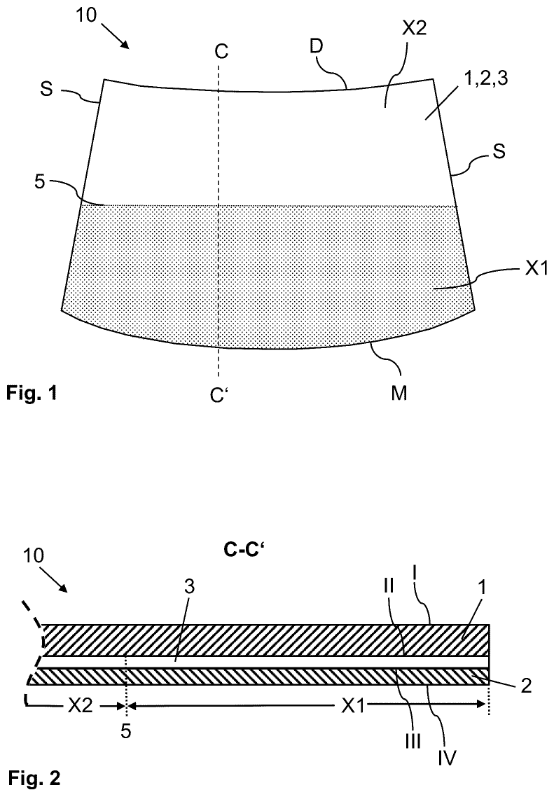

FIG. 1 shows a plan view of an embodiment of a windshield according to the invention,

FIG. 2 shows a section of a cross section through the embodiment of a windshield according to the invention shown in FIG. 1, and

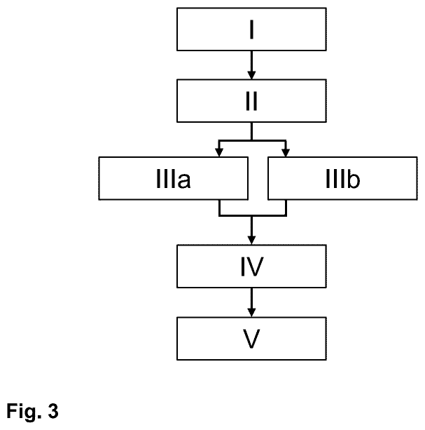

FIG. 3 shows a flowchart of an embodiment of the method according to the invention.

FIG. 1 shows the top view of an embodiment of a windshield 10 according to the invention, while FIG. 2 shows a detail of a cross section through the embodiment shown in FIG. 1 along the section line C′-C according to FIG. 1.

The windshield 10 shown in FIGS. 1 and 2 comprises an outer pane 1 and an inner pane 2, which are connected to one another by a thermoplastic intermediate layer 3. The outer pane 1 has an outer surface I and an interior-side surface II. The inner pane 2 has an outer surface III and an interior-side surface IV. When the windshield 10 is installed, the outer surfaces I, III are oriented in the direction of the surroundings, while the interior-side surfaces II, IV are oriented toward the vehicle interior in the installed state. The interior-side surface II of the outer pane 1 is connected to the outer surface III of the inner pane 2 via the thermoplastic intermediate layer 3. The windshield 10 has a roof edge D, an engine edge M opposite the roof edge and two side edges S opposite one another, which connect the engine edge M and the roof edge D to one another. The windshield 10 has a first surface region X1 and a second surface region X2, wherein the first surface region X1 is arranged adjacent to the engine edge M.

In the first surface region X1, the windshield 10 has a surface compressive stress of 15 MPa to 30 MPa on the interior-side surface IV of the inner pane 2, while in the second surface region X2, there is a surface compressive stress of 2 MPa to 10 MPa on the interior-side surface IV of the inner pane 2. The outer pane 1 is, for example, a glass pane made of soda-lime glass with a thickness of 2.1 mm. The inner pane 2, for example, is made of soda-lime glass and has a thickness of 1.6 mm.

The first surface region X1 has an upper edge 5 that, starting from the engine edge M, is arranged offset in the direction of the roof edge D. The upper edge 5 of the first surface region X1 runs between the side edges K, wherein between the upper edge 5 of the first surface region X1 and the engine edge M there are higher surface compressive stresses on the interior-side surface IV of the inner pane 2 than on the interior-side surface IV of the inner pane 2 between the upper edge 5 and the roof edge D. This has proven to be particularly advantageous in order to achieve a later breakage of the windshield 10 in the first surface region X1 in the head impact test.

If the windshield 10 according to FIGS. 1 and 2 is installed in a conventional motor vehicle with a dashboard, the size of the first surface region is preferably selected such that the projection of the dashboard onto the windshield 10 lies within the first surface region X1. In the region of the dashboard, the increase in surface compressive stress is intended to cause a late breakage. The late breakage of the glass leads to a greater bending of the pane, wherein the kinetic energy of the head is stored as elastic energy. This elastic energy is used to create new surfaces when the windshield breaks. Therefore, a later breakage results in a lower penetration depth of the head as a higher amount of energy is dissipated from the impacting head. This later breakage is particularly advantageous in the region of the dashboard, since the impact of the head on the rigid dashboard located behind the windshield results in a very high amplitude and a long-lasting deceleration peak (approximately 15 ms to 17 ms), resulting in very high HIC values. For this reason, the initial higher deceleration peak caused by the elastic bending of the pane is less problematic because it reduces the amplitude of the secondary impact peak with the dashboard, thereby reducing the HIC value.

FIG. 3 depicts a preferred embodiment of the method according to the invention comprising the steps of:
I providing an outer pane 1 and an inner pane 2,
II heating the outer pane 1 and the inner pane 2 to at least their softening temperature,
IIIa joint bending of the outer pane 1 and the inner pane 2 in a gravity bending method and optionally further joint bending of the outer pane 1 and the inner pane 2 in a press bending method, or
IIIb joint bending of the outer pane 1 and the inner pane 2 in a press bending method,
IV cooling the outer pane 1 and the inner pane 2, wherein the inner pane 2 is cooled in the first surface region X1 at a first cooling rate A1 and the inner pane 2 is cooled in the second surface region X2 at a second cooling rate A2 and the absolute value of the first cooling rate A1 is greater than the absolute value of the second cooling rate A2,
V laminating the outer pane 1 and the inner pane 2 with the interposition of a thermoplastic intermediate layer 3 to form a composite pane 10.

### LIST OF REFERENCE SIGNS

10 Windshield
1 Outer pane
2 Inner pane
3 Thermoplastic intermediate layer
5 Upper edge of the first surface region X1
X1 First surface region
X2 Second surface region
D Roof edge
M Engine edge
S Side edges
CC′ Cutting line
Outer surface of the outer pane 1
Interior-side surface of the outer pane 1
III Outer surface of the inner pane 2
IV Interior-side surface of the inner pane 2

1. A method for producing a windshield comprising at least one outer pane made of glass, an inner pane made of glass, a thermoplastic intermediate layer, a roof edge, an engine edge, two side edges running therebetween, a first surface region immediately adjacent to the engine edge and a second surface region immediately adjacent to the first surface region between the first surface region and the roof edge, the method comprising:
(a) providing an outer pane and an inner pane,
(b) heating the outer pane and the inner pane to at least their softening temperature,
(c) jointly bending the outer pane and the inner pane or individually bending the outer pane and the inner pane,
(d) cooling the outer pane and the inner pane,
(e) laminating the outer pane and the inner pane with the interposition of a thermoplastic intermediate layer to form a composite pane,
wherein in step d) the outer pane and/or the inner pane are/is cooled in the first surface region at a first cooling rate and the outer pane and/or the inner pane are/is cooled in the second surface region at a second cooling rate, and an absolute value of the first cooling rate is greater than an absolute value of the second cooling rate, the first and second cooling rates in the associated first and second surface region prevailing at at least one pane surface of the inner pane and/or of the outer pane.

2. The method according to claim 1, wherein a ratio between the first cooling rate and the second cooling rate is greater than or equal to 2.

3. The method according to claim 1, wherein the outer pane and/or the inner pane are cooled in the first surface region at a first cooling rate between 6 K/s and 20 K/s.

4. Metho The method according to claim 1, wherein the outer pane and/or the inner pane have a temperature of at least 500° C., at the start of the cooling process in step d).

5. The method according to claim 1, wherein the cooling in step d) is carried out by convection or radiation.

6. The method according to claim 1, wherein the outer pane and the inner pane are bent in step c) in a gravity bending method.

7. The method according to claim 1, wherein the outer pane and the inner pane are bent simultaneously in pairs or successively individually in step c) by means of press bending.

8. A windshield obtainable by a method according to claim 1, comprising an outer pane made of glass with an outer surface and an interior-side surface, an inner pane made of glass with an outer surface and an interior-side surface, a thermoplastic intermediate layer which connects the interior-side surface of the outer pane to the outer surface of the inner pane, a roof edge, an engine edge, two side edges running therebetween, a first surface region immediately adjacent to the engine edge and a second surface region immediately adjacent to the first surface region between the first surface region and the roof edge, wherein the outer pane and/or the inner pane in the first surface region has a surface compressive stress of 11 MPa to 50 MPa and the outer pane and/or the inner pane in the second surface region has a surface compressive stress of 2 MPa to 10 MPa.

9. The windshield according to claim 8, wherein in the first surface region a surface compressive stress of 11 MPa to 50 MPa is present on the interior-side surface of the outer pane and/or on the interior-side surface of the inner pane.

10. The windshield according to claim 8, wherein the first surface region takes up a proportion of 10% to 70% of a total surface area of the composite pane.

11. The windshield according to claim 8, wherein the first surface region extends at least in portions from the engine edge by an amount in the direction of the roof edge that corresponds to 10% to 70% of the height of the windshield.

12. The windshield according to claim 11, wherein a size of the first surface region is selected such that, in an installed state of the windshield in a motor vehicle, the size of the first surface region (X) corresponds to at least 90% of the area of the projection of the dashboard of the motor vehicle onto the windshield.

13. The windshield according to claim 8, wherein the thermoplastic intermediate layer comprises polyvinyl butyral (PVB), polyurethane (PU), ionomers and/or ethylene vinyl acetate (EVA).

14. The windshield according to claim 8, wherein the outer pane and the inner pane each have a thickness of 0.8 mm to 2.5 mm.

15. A motor vehicle comprising a windshield according to claim 8, wherein a size of the first surface region is selected such that, in an installed state of the windshield in the motor vehicle, the size of the first surface region (X) corresponds to at least 90% of an area of the projection of the dashboard of the motor vehicle onto the windshield.

16. The method according to claim 2, wherein the ratio between the first cooling rate and the second cooling rate is between 2 and 3.

17. The method according to claim 3, wherein the first cooling rate is between 10 K/s and 15 K/s.

18. The method according to claim 4, wherein the outer pane and/or the inner pane have a temperature of at least 520° C. at the start of the cooling process in step d).

19. The method according to claim 6, wherein the outer pane and the inner pane are bent congruently in a gravity bending method.

20. The windshield according to claim 10, wherein the first surface region takes up a proportion of 15% to 50% of the total surface area of the composite pane.
